(19) United States
(12) Patent Application Publication
(10) Pub. No.: US 2018/0005183 A1
(43) Pub. Date: Jan. 4, 2018

(54) System and Methods for Smart and Secure Package Receivers

(71) Applicants: Cuong Manh Nguyen, Hanoi (VN); Hoa D. Nguyen, Cedar Hill, TX (US); Phuong Thi Xuan Pham, Hochiminh (VN); Hoang Dat Kieu, Hanoi (VN)

(72) Inventors: Cuong Manh Nguyen, Hanoi (VN); Hoa D. Nguyen, Cedar Hill, TX (US); Phuong Thi Xuan Pham, Hochiminh (VN); Hoang Dat Kieu, Hanoi (VN)

(21) Appl. No.: 15/196,040

(22) Filed: Jun. 29, 2016

(51) Int. Cl. G06Q 10/08; G07C 9/00; G06Q 30/06; H04W 4/02; G06F 21/62

(52) U.S. Cl. CPC G06Q 10/0836; H04W 4/021; G06F 21/6245; G06Q 30/0635; G07C 9/00912

(57) ABSTRACT

A smart and secured system to receive packages from online shopping; automatically download list of incoming packages from one or multiple linked online-shopping accounts; provide navigational support to postal carriers and/or autonomous delivery; print receipts for validation; send encrypted confirmation to home-owners when any packages arrives; and implement an a. The system compromises of a secure box with a magnetic lock to store packages; a control circuitry, mini thermal printer and embedded processor to recognize and validate the arrived packages; a radio-frequency transceiver to wirelessly communicate with other electronic devices to notice information of the packages; and global positioning system (GPS) tracking tags for anti-theft protection. The software application operating on the electronic devices including but not limited to smartphones, smartwatches, tablets and/or computers allows to receive notifications from the smart receiver, and establish real-time communication between the home-owners and the postal carriers. The GPS tracking tags are used to support un-maned delivery with drones and track the location of the packages. The system powered by solar energy is portable and easy to be installed. The smart and secure receiver that is able to automatically realize the packages, hold the packages, print the electronic receipts for endorsement and send notifications to the home-owners could eliminate the need of the receiver's presence during delivery.

### FIELD OF THE INVENTION

The invention disclosed herein relates to an automatic, smart and secure receiver that could receive packages on behalf of the home-owners.

### BACKGROUND OF THE INVENTION

Shipping companies such as FedEx, USPS, and UPS use a physical address to deliver a parcel from online shopping. The postal carriers have three options to deliver the parcel (1) intentionally leave it in front of the door or inside the buyer's mailboxes; or (2) only deliver the guaranteed parcel to the buyers after having an authorized signature; (3) or take the guaranteed parcel back to the designated post-office if nobody is present when delivery. In the first case, the parcel may be stolen if it is left unattended. The buyers thereby are encouraged to use the guaranteed delivery method for the costly parcel. However, the buyers need to be present at the delivery moment because a signature is required for endorsement. This becomes a hassle to the buyers since the delivery moment is mostly not fixed. In the worst case, if the buyers keep missing the delivery moment for three times, the postal carriers will schedule the buyers to pick the parcel up at the designated post-office. In rural areas, it may take hours for the buyers to travel to the post-office for picking up. This whole process may waste time, money and efforts of both the buyers and the postal carriers.

### SUMMARY OF THE INVENTION

This invention discloses an autonomous and secure package receiver that could track status of online orders, automatically collect the package and print out the confirmation for the postal carriers.

It is necessary to make clear about the function of the smart receiver. It is an apparatus to receive the packages on behalf of the home-owners. The design of the apparatus is compatible with online shopping where it can store the information of the buyers so that the buyers do not need to input their address and billing information while ordering. The apparatus has a capability to access to Internet or cloud server to download the buyers' database and ordering information.

The smart receiver is assigned with an identification (ID) representing a digital address which is shared with the post-office's or delivery companies' databases. The smart receiver can receive any regular mails and be compatible with the traditional mailing system.

The system includes a built-in software application and a secure box controlled by a driver circuitry, namely a control unit center. The secure box are made of materials that are resistant to harsh weather conditions or external physical forces. The secure box in this illustrative embodiment has a rectangular shape. Another alternative embodiments could have different shapes or combination of different shapes including but not limited to cylinders, cubes, ovals and/or spheres. The control unit center could communicate with other electronic hand-held devices, computers and routers of the home-owners.

The receiver could collect information of incoming packages through the home-owners' smart devices. The receiver is also designed to directly access to the home-owners' online shopping accounts including but not limited to Amazon.com and eBay.com. Once the home-owners finish ordering, the information and delivery date of packages are automatically transferred to the smart receiver.

This apparatus and system act on behalf of the home-owners to receive the arriving packages. The control unit center has capability to communicate with postal carriers to validate the packages. If a signature is required for the guaranteed packages, the smart receiver prints a receipt for endorsement. The postal carriers can then place the packages inside the secure box. The packages that are not fit into this secure box can be placed outside with attached GPS tags. This helps the receiver to monitor the location of the out-of-door packages and send alarms to the home-owners if these packages are dislocated. The home-owners can track the movement of the packages using a built-in software application installed in computers and/or hand-held smart devices. The fully autonomous and secure receiving process allows online-shipment to be delivered without the presence of the home-owners.

The built-in software is compatibly designed for electronic devices that are supporting Wi-Fi connection such as smartwatches, smartphones, tablets, laptops and personal computers. The software has a user friendly interface allowing the home-owners to connect and control the smart receiver.

Communication between the electronic hand-held devices and the control unit center inside the smart receiver is two-way communication compatible with or without a cloud server. The hand-held devices send information of incoming packages to the receiver while the secure box can notify the hand-held devices any the packages' arrival. In this illustrative embodiment, the cloud server shares ordering information, billing addresses and the status of the shipping packages among all electronic devices. In other embodiments, the home-owners have an option to configure a specific electronic device as a personal server. This allows other electronic devices to access and share information without any cloud server. All information transferring between devices is securely encrypted.

In the illustrative embodiment, the control unit center of the secure box compromises of a processor, magnetic lock, thermal printer, speaker and microphone, radio-frequency (RF) wireless transceiver, Bluetooth low energy transceiver, GPS tags and solar panel system. The RF wireless transceiver connects to the Wi-Fi router at home to establish a secure communication between the secure box and the wireless local area network (WLAN). The control unit center can access to the home-owners' accounts to download personal information of the incoming packages. Once the packages arrive, the control unit center will send instant messages or notifications to the home-owners.

The smart receiver described herein could be mounted to the fence, front door or placed anywhere in a house. It is visually perceptible to the postal carriers. In an illustrative embodiments, the smart receiver may have a light-emitting diode (LED) array to signal the postal carriers. In other embodiments, they have a GPS transceiver for the postal carriers to locate them with any GPS tracking devices. The GPS transceiver also benefits for drones to navigate in un-maned delivery approaches.

The smart receiver also implements tracking technology to monitor the locations of packages that are keeping nearby. A GPS tag is attached on the packages by the postal carriers. The control unit center thereby monitors the location of this package. Alarm will be activated if any displacement is detected. An instant message is sent to the electronic devices. The home-owners are able to monitor the movement of the packages. In some embodiments, a speaker and microphone are equipped to establish communication between the home-owners and the one moving the packages. The approach improves security levels since it allows the remoted home-owners attentively watching over the arrived packages. Some other embodiments are implemented surveillance sensors, including but not limited to infrared detectors and/or ultrasound sensors, to monitor the packages. This intrusion prevention option is a well alternative choice for the GPS tags as it could monitor a group of packages.

In an illustrative embodiment, the smart receiver has communication with the home-owners through wireless radio frequency such as Wi-Fi and Bluetooth low energy connection. The Wi-Fi protocol allows the smart receiver to directly connect to the home router and link to a cloud server, while the Bluetooth low energy protocol requires a hand-held electric devices having authority to access to the cloud server. The home-owners can download a list of pending packages into the external memory of the smart receiver. The incoming packages will be sorted by control unit center. If endorsement or a signature is required for delivery, the smart receiver could send a request to the home-owners and establish communication with the postal carriers. In this particular embodiments, the smart receivers have a built-in speaker and microphone to help the home-owners to talk directly to the postal carriers. Such conversation eliminate the need of the home-owners' presence during delivery. In other embodiments, the smart receivers have a built-in thermal printer to automatically provide signature or validation when the home-owners acknowledge the packages' arrival. The smart receivers could issue a verification code and send directly to the post-office or delivery companies, which thereby no signature is necessary.

In an illustrative embodiment, the smart receiver has solar panels for self-powering. In addition, it has batteries as the back-up power sources. The batteries are rechargeable by the solar panels during day time. The control unit center of the smart receiver can monitor the capacity of the batteries and trigger alarms if the batteries become low. In some embodiments that are not using any batteries or solar panels, they are powered by connecting directly to the main power lines at home. The control unit center of the smart receiver also implements low-power circuitry to optimally minimize power consumption.

### Advantageous Effects of Invention

The invention disclosed herein is compatible with any current delivery methods from contemporary delivery companies including but not limited to FedEx, United States Postal Service (USPS), and United Parcel Service (UPS). Although the aim of this invention is not replacing the current delivery methods, it supports and improves the quality and security levels of the traditional delivery methods. The advantages of this invention for the current delivery methods and home-owners include cost savings, time savings and improved risk management for online shopping.

The invention discloses a secure and automated receiver to receive guaranteed parcels. The machine-like receiver comprises a secure box to store the parcels. The secure box only opens when the identities of the postal carriers and the home-owners are verified. One of the main innovations is that this receiver is able to print a receipt to the postal carriers for endorsement. The receipt is a replacement of the buyers' signature. The buyers benefits from this autonomous receiver because of non-necessity to be present during delivery moment. Meanwhile, this feature also helps postal carriers lessen hassles of coming back and forth for guaranteed parcels. The smart receiver has a control unit center to verify the package and send notifications to the buyers, online shopping companies and delivery companies when the packages are delivered.

The invention also improves risk management by having an intrusion prevention function. The postal carrier attaches GPS tags on the parcels that are kept outside of the secure box. The anti-theft feature is then initiated to continuously monitor the parcels' location. Any unverified movement of the parcels will be immediately notified to the home-owners. The autonomous tracking system integrated inside the smart receiver update locations of the parcels if they are stolen. The home-owners can provide such information to police or designated security forces.

The smart receiver in this invention has a digital address identification or ID that could be linked to the delivery companies. This enables an autonomous delivery method using drones or any un-maned devices. The drones benefitting from global positioning system can navigate to the smart receiver and drop the packages. The smart receiver described herein has capabilities of not only communicating with the postal carriers but also machine-based delivery objects.

### BRIEF DESCRIPTION OF THE DRAWINGS

The apparatus and method for smart and secure receivers are described below. In this description, reference will be made to the accompanying drawings, which are not necessarily drawn to scale, and wherein:

FIG. 1 illustrates a perspective view of a smart receiver;

FIG. 2 illustrates a top view of a smart receiver;

FIG. 3A illustrates a front view of a smart receiver with opening door;

FIG. 3B illustrates a front view of a smart receiver with closing door;

FIG. 4A illustrates flow diagram to achieve incoming package list;

FIG. 4B illustrates a connection to a home via Wi-Fi;

FIG. 4C illustrates a connection to a mobile device via Bluetooth;

FIG. 5 shows steps to obtain and process information of incoming packages in the smart receiver;

FIG. 6 illustrates steps performed when delivering a package to a smart receiver;

FIG. 7 depicts a flow chart that generally illustrates steps performed by a smart receiver to receive a package;

FIG. 8 depicts a cross-sectional picture of an attachable GPS tag accompanying with a smart receiver.

FIG. 9A illustrates the smart receiver monitors the out-of-door packages having proximity sensors such as acoustic sensors or light sensors;

FIG. 9B illustrates steps performed by the smart receiver while monitoring the packages.

### DETAILED DESCRIPTION

Detailed embodiments of the smart receiver are disclosed herein. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Generally, a smart receiver compromises of at least five advanced functions and capabilities: (1) automatically download list of incoming packages in online shopping, (2) establish a wired call to the home-owners, (3) send notifications and/or alerts to the home-owners, (4) print receipts to the postal carriers and (5) securely contain packages. The smart receiver is controlled by a control unit center and able to establish connection to any authorized electronic devices supporting wireless communication or web service through Bluetooth low-energy and Wi-Fi connection. The smart receiver integrates a speaker and microphone that allows the postal carriers to communicate directly with the home-owners. This embodiment of the smart receiver is powered by solar panels or power lines.

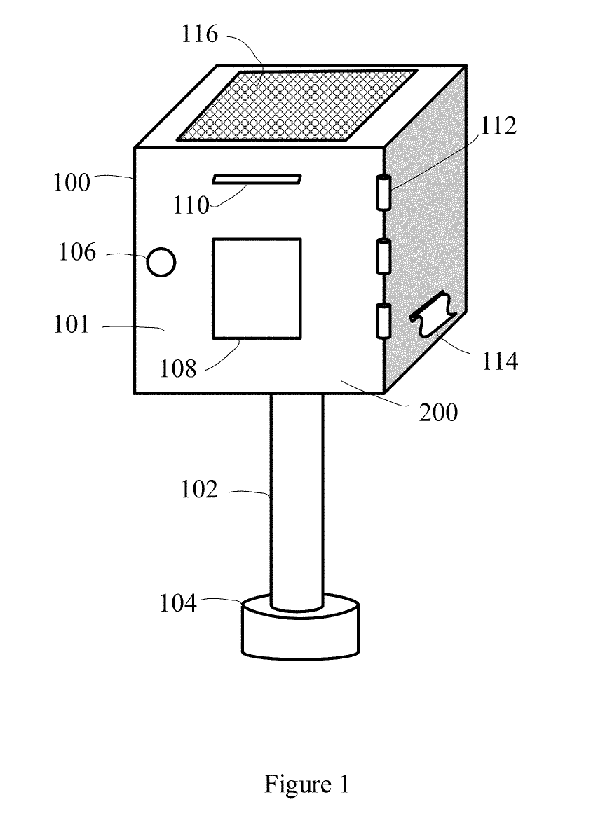

Referring now to the invention in more detail, FIG. 1 illustrates the perspective view of the smart receiver. In this illustrative embodiment, a smart receiver 100 compromises of a secure box 101, pole 102 and stand 104. The secure box 101 is made of materials which could repel harsh weather or external physical forces. Some materials including but not limited to steel, acrylic or poly-vinyl chloride (PVC) plastics are used. In the illustrative embodiment, the secure box 101 has a rectangular shape; however, it can be any shape or combination of different shapes, which are able to hold objects or packages. The length of the pole 102 and size of the stand 104 are varied to adapt to different mounting conditions. In an alternative embodiment, the smart receiver 100 could be mounted on the wall and/or front door; thereby, the pole 102 and the stand 104 are not necessary. The solar panel 116 on top of the secure box 101 serves as the energy source for the electrical circuit and control unit center inside the smart receiver. The door 200 attaching to the secure box with hinges 112 could be opened with a knob 106. The display control panel 108 is located on the door 200 as shown in FIG. 1; however, it can be placed on the side in other embodiments.

As shown in FIG. 1, the slid 110 is designed for the postal carriers to quickly drop any regular envelop or packages. This allows the postal carriers spend minimum time while delivering regular mails. The smart receiver has an integrated printer to print receipts 114 for guaranteed parcels which require endorsed signatures from the home-owners. This feature allows the parcels to be delivered even without the home-owner's presence.

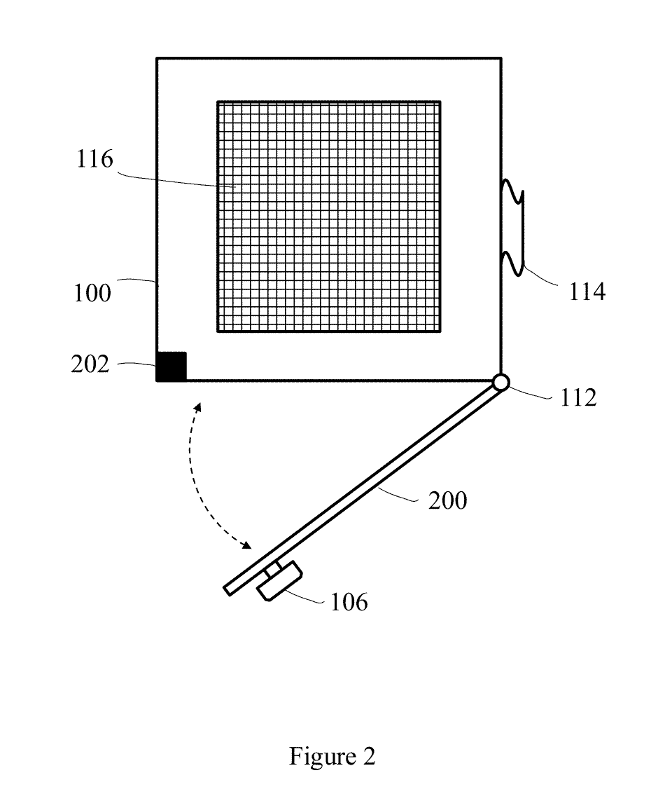

The top view of the smart receiver 100 is shown in FIG. 2. The solar panel 116 is placed on top of the smart receiver 100. In other embodiments, the solar panel 116 may consist of multiple small panels which are placed in different angles to have highest exposure to the sun during day time. FIG. 2 illustrates the smart receiver door 200 which can be opened and closed with the support of the hinges 112. In normal conditions, the door is locked with the magnetic lock 202 which is controlled by the control unit center. Once opening commands are executed, the magnetic lock 202 will release the door 200 and the postal carriers can open with the knob 106. In this embodiment, the door 200 could be open to the side. In some other embodiments, the door 200 can be open up-side-down. The simple embodiments may not have the automatic magnetic lock 202. In such case, the postal carriers will just use a physical key to open the secure box. However, the feature of printing receipts 114 is still available.

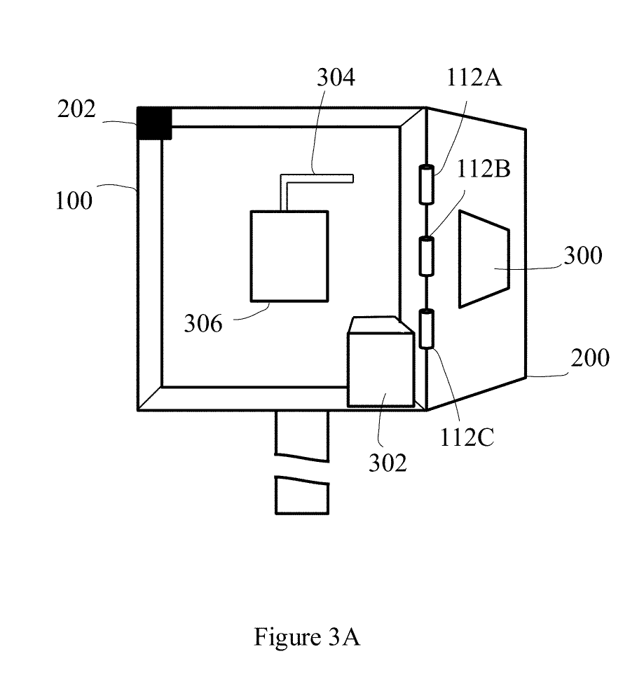

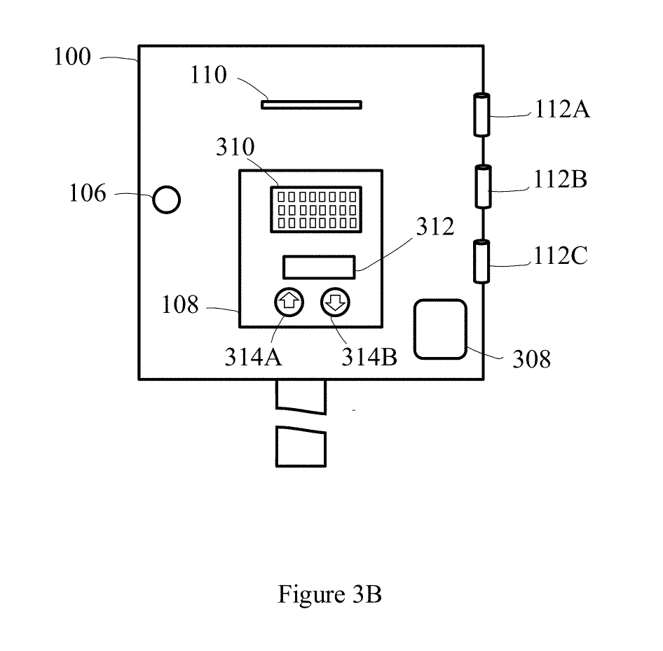

The front view of the smart receiver 100 with an opening door is illustrated in FIG. 3A. The circuit board 300 for the display control panel 108 is attached to the door 200. In other embodiment, the display control panel 300 can be placed to the side of the smart receiver 100 to reduce the door's weight. The door 200 can be opened by rotating along with the three hinges 112A, 112B, and 112C.

In more detail, still referring to the FIG. 3A, a mini thermal receipt printer 302 is located inside the smart receiver 100 to print the receipt 114. The use of the printer 302 allows the smart receiver be compatible with current mailing system that requires endorsed signatures for guaranteed parcels. However, in some other embodiments where electronic signatures are used, by which notifications are sent directly to the post offices once the packages are delivered, the printer 302 is not necessarily included in the system.

As shown in FIG. 3A, a circuit board of the control unit center 306 and wireless antennas 304 are attached on the back of the smart receiver 100. The control unit center 306 controls the display control panel 300, thermal printer 302, and magnetic lock 202. It also handles the wireless communication to the home Wi-Fi router, and any authorized electronic devices. The control unit center 306 support both Wi-Fi and Bluetooth connections that make it more convenient to the users.

FIG. 3B illustrates the front view of the smart receiver 100 with a closing door. The speaker and microphone 308 allows the postal carriers to talk with the home-owners to verify information of the incoming parcels. In some embodiments where such communication is not needed, the speaker and microphone 308 is not included. The display control panel 108 compromises of an input keyboard 310, display 312 and navigation buttons 314. The postal carriers can use the input keyboards 310 to enter access code that allows to open the secure box. The display 312 interactively illustrates options for the postal carriers to choose while the navigation buttons 314 allow to move between options. In other embodiments, the display control panel 108 could be a touch screen.

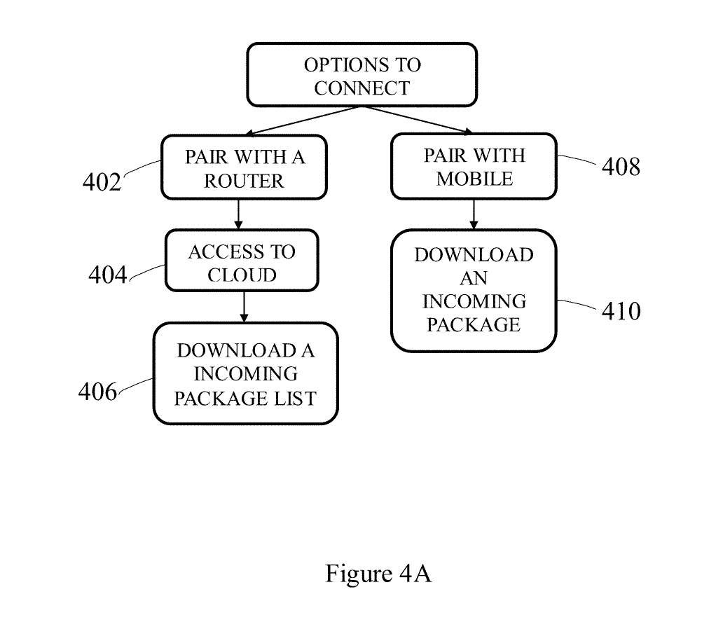

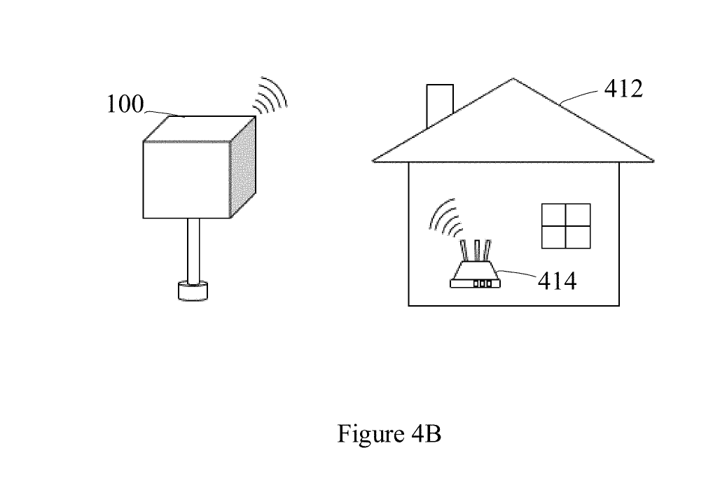

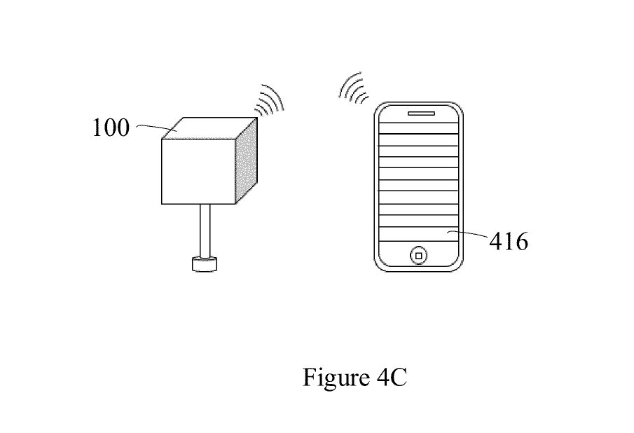

Referring now to the invention shown in FIG. 4A illustrating the flow of chart that allows the smart receiver 100 to download a list of incoming packages. The list can be loaded automatically since the smart receiver can connect to Internet through (1) a home router and (2) a mobile devices. In the first approach, the smart receiver can pair with the home router via Wi-Fi connection in the step 402. Afterwards, it can connect to the server 404 download the list of incoming package 406. The server is set up by the home-owners. Secondly, the smart receiver 100 can pair with a mobile device via Bluetooth connection in the step 408. Bluetooth low-energy protocol is utilized for energy saving. In the second approach, the built-in application from the electronic device storing information of incoming packages can thus be downloaded to the smart receiver in the step 410.

FIG. 4B illustrates the connection of the smart receiver 100 to the home router 414 inside a house 412. FIG. 4C shows the capability of the smart receiver 100 to pair with a smart phone 416. A built-in application is developed to support communication between the smart receiver and the mobile device.

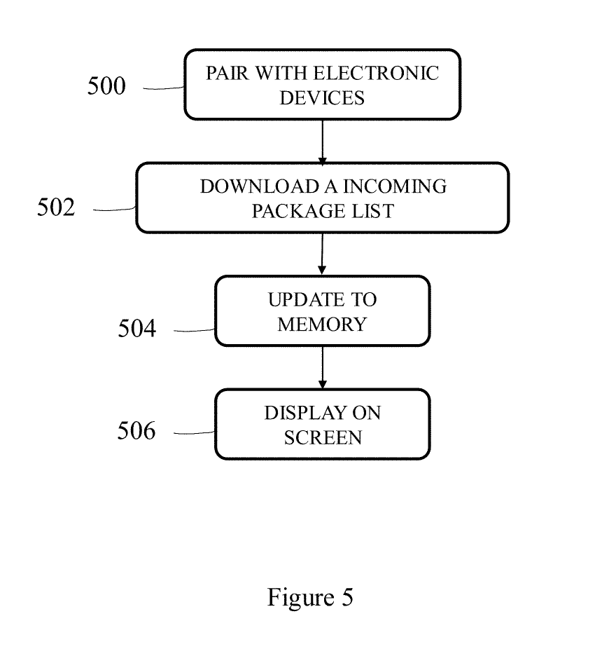

Referring now to the FIG. 5 which shows steps for the smart receiver to obtain information from the home-owners' accounts. Once the receiver connects to a server or pairs with the electronic devices, it achieves information of the incoming package in the step 502. These information will be updated to the external memory of the control unit center, the step 504. In this embodiment, a secure digital (SD) memory card is utilized as the memory. The information will be displayed on the screen 312 in the step 506. The frequency to download information of incoming packages can be programmable. In this embodiment, the list is downloaded in the morning each day. The information will be then refreshed and updated on the screen 312.

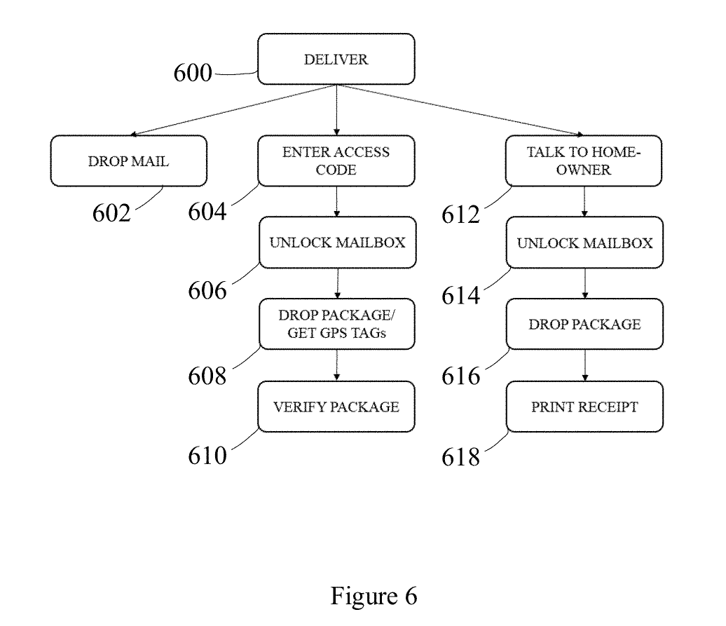

The postal carriers have three options to deliver a package as shown in FIG.6. In the first option, if the package is small, the postal carriers just drop it through the slid 110 on the door 200 as in the step 602. In the second option, if the post carriers need to open the smart receiver, they enters the access code 604 using the input keyboard 310 on the display control panel. The postal carriers can also access to the smart receiver using an authorized hand-held device that supports Bluetooth low-energy protocol. When the receiver door is unlocked in the step 606, the postal carriers can drop the package if it fits into the secure box. In the case of an unfit package, the postal carriers can take a GPS tag and attach on the package 608. The control unit center then starts monitoring the location of the package with the attaching GPS tag. In other embodiments, the control unit center can utilize proximity sensors, for instance sound sensors to locate the package. Afterward, the postal carriers can verify the package 610 from the list displaying on the screen 312. At this moment, the navigation buttons 314 are helpful to find the package in the list. In the third options, the postal carriers can choose to talk to the home-owners 612 using the speaker and microphone. The secure box then can be remotely unlocked in step 614. The postal carriers deposit the package 616 and print receipts 618.

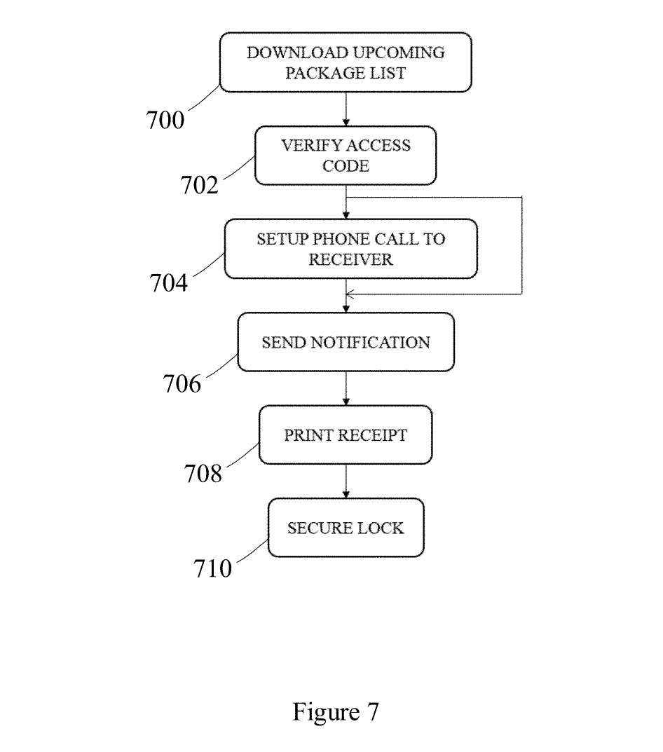

FIG. 7 illustrates steps that the smart receiver performs to receive a package. At first, the receiver downloads the list of incoming packages 700 every day. When the postal carriers enter access code and request to talk to the home-owners, the smart receiver will verify their authorization in the step 702. The smart receiver afterwards sets up a phone call to the home-owners. The phone call can be made via telephone line or through Wi-Fi connection. The home-owners can also program to receive the package without needs of validation; thereby the step 704 might be ignored. After the postal carriers deposit the package, the smart receiver will send a notification, instant message or over-the-top content (OTT) message 706 to the home-owners via Wi-Fi connection. The smart receiver prints out the receipts to the postal carriers in the step 708. In other embodiments that electronic signatures are accepted, the step 708 can be replaced with sending notifications directly to the delivery companies. Eventually, the secure box will be automatically locked as in the step 710.

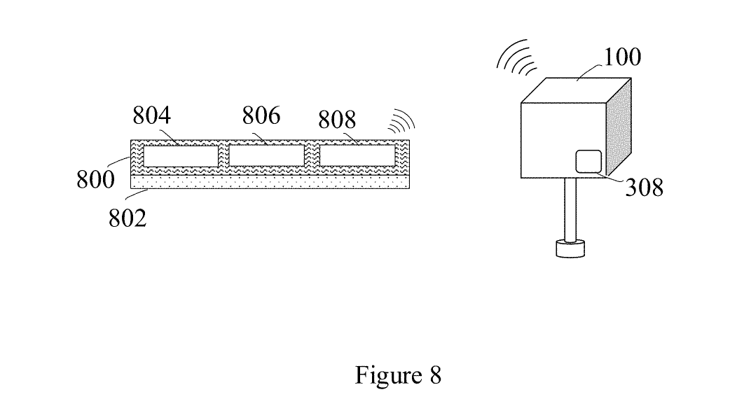

In the FIG. 8, a cross-sectional picture of a GPS tracking tag 800 is illustrated. The GPS tracking tag has a glue layer 802 that helps it attach to the package. Each GPS tracking tag compromises of three main components: a coin battery 804, a GPS chip and antenna 806, and a microcontroller 808. In this embodiment, the GPS chip and antenna 806 receive location information from satellite, digitize this information and send to the integrated microcontroller 808. The microcontroller 808 communicates with the smart receiver 100 via the Bluetooth low energy protocol. The two devices can maintain connection up to 150 feet. If the smart receiver 100 detects any displacements of the package, theft detection is triggered. The smart receiver sends alarm and notifications to the home-owners. The smart receiver also can activate the speaker 308. Notification or alerts are also sent to the home-owners. In other embodiments, the location of the GPS tracking devices can be monitored via satellites, which helps to track the package in further distances.

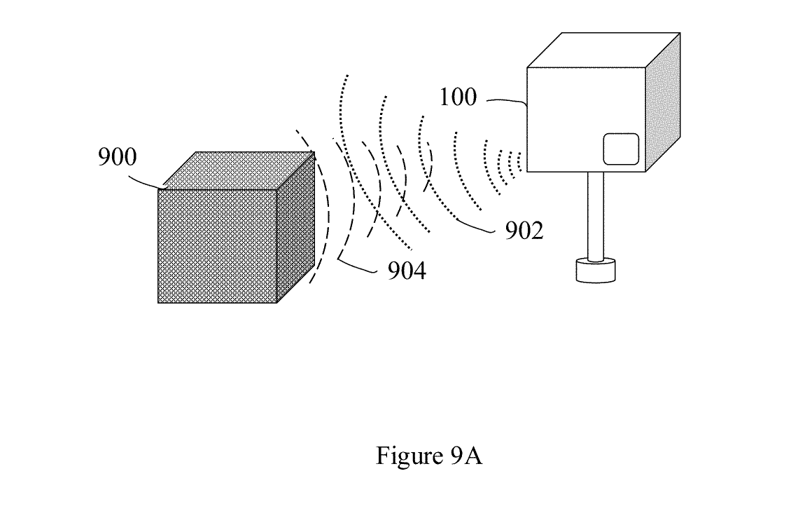

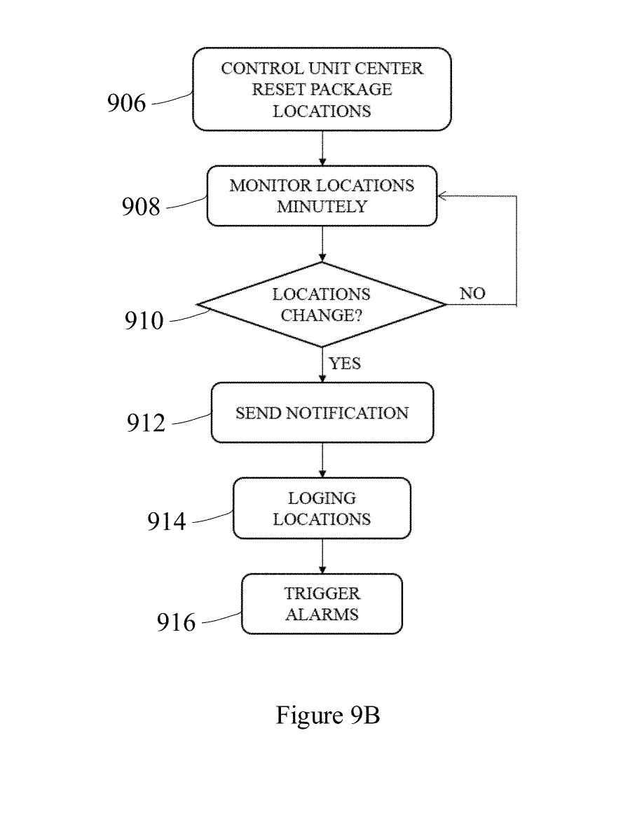

Some other embodiments use low-cost proximity sensors such as acoustic sensors or light sensors instead of the GPS tracking devices. FIG. 9A illustrates the smart receiver monitors the out-of-door package using such proximity sensors. The smart receiver 100 sends an incident wave 902 toward the package. The incident wave 902 hits the package and reflects back, shown as the reflection wave 904 in the FIG. 9A. The control unit center detects the reflection wave 904 and recognizes the distance between the package 900 and the receiver 100. Any dislocation of the package 900 could cause change in the reflection wave 904 that would trigger the control unit center.

FIG. 9B illustrates steps performed by the smart receiver while monitoring the package. Firstly, the control unit center remembers the location of the package in the step 906. Afterwards, it keeps monitoring the location of the package 908. If the location changes, the control unit center will send a notification to the home-owners in the step 912. It also starts logging the location of the package for further investigation 914. The control unit center can trigger alarms if necessary 916.

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, the smart receiver device described in this embodiment may include different types or number of sensors and actuators, such as, speaker and microphones, wireless transceivers or thermal printer, etc. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation.

What is claimed is:

1. A smart and secure receiver which allows postal carriers to deliver any package securely without physical presence of home-owners comprises:
i. a secure box made of materials, which repels to weather and physical forces, having a controllable magnetic lock;
ii. a control unit center consisting a microcontroller, a speaker and microphone, a thermal printer, a Bluetooth low-energy transceiver, a Wi-Fi transceiver to communicate with home wireless local area network;
iii. a built-in software application to access encrypted information of said home-owners' accounts that are used in online shopping;
iv. a display control panel helping postal carriers to search and/or navigate to the information of packages to be delivered;
v. GPS tracking devices attachable to packages for intrusion prevention.

2. The system of claim 1, wherein said magnetic lock is a normally closed switch and can be opened by said control unit center.

3. The system of claim 2, wherein said magnetic lock is triggered to open using authorized electronic devices pairing with said control unit center via Bluetooth low-energy transceiver.

4. The system of claims 1 and 3, wherein home-owners or postal carriers can use said mobile devices to open said secure box with said built-in application software.

5. The system of claim 4, wherein postal carriers can use a pre-set encrypted code, which is provided or set up by said home-owners, to open said secure box, which allows to eliminate the use of any physical key.

6. The system of claim 1, wherein said postal carriers can communicate with said home-owners using said speaker and microphone of said control unit center.

7. The system of claim 1, wherein said postal carriers can obtain receipts printed automatically by said smart receiver without presence of home-owners while delivering.

8. The system of claim 1 and 7, wherein said printer can be replaced with electronic signature or endorsements that will be automatically sent to delivery companies by said smart receiver through Wi-Fi connection.

9. The system of claim 1, wherein said control unit center can connect to wireless local area network via a home router or via said paired electronic devices.

10. The system of claim 1 and 9, wherein said control unit center access to said home-owners' online shopping accounts to download list of incoming packages via said home router or via said paired electronic devices.

11. The system of claim 1 and 10, wherein said control unit center shows information of said list of incoming packages on said display control panel.

12. The system of claim 1, wherein said GPS tags are provided for said postal carriers to attach on packages that are physically kept outside of said secure box. Intrusion prevention is activated as said home-owners can use said GPS tracking devices to track the movement of said out-of-door packages.

13. The system of claim 1 and 12, wherein said control unit center monitors the locations of said out-of-door packages using said GPS tags, and/or proximity sensors, which are able to detect the presence of a nearby object, for theft prevention.

14. The system of claim 1, wherein a notification or confirmation will be sent to said home-owners once any package get delivered.

15. The system of claim 1, wherein said smart receiver is solar-powered or directly powered from home power lines.

16. The system of claim 1, wherein said smart receiver may consist of a GPS device allowing automatic delivery by drones.
